(19) United States
(12) Patent Application Publication
(10) Pub. No.: US 2006/0048980 A1
(43) Pub. Date: Mar. 9, 2006

(54) Force input operation device, movable body, carrying vehicle, and auxiliary vehicle for walking

(75) Inventors: Shinya Kataoka, Osaka (JP); Naoto Toujou, Nara (JP)

Correspondence Address: DARBY & DARBY P.C., P. O. BOX 5257, NEW YORK, NY, 10150-5257, US

(73) Assignee: SANYO ELECTRIC CO., LTD., MORIGUCHI-SHI OSAKA (JP)

(21) Appl. No.: 10/542,397

(22) PCT Filed: Feb. 16, 2004
(86) PCT No.: PCT/JP04/01657

§ 371 Date: Jul. 12, 2005

(30) Foreign Application Priority Data
Feb. 17, 2003 (JP) 2003-038448

(51) Int. Cl. B62D 51/04

(52) U.S. Cl. 180/19.2

(57) ABSTRACT

A manipulator for a mobile object which allows operating the mobile object with a natural feeling without difficulty irrespective of the physical condition of the user, and a push cart and a walker including such a manipulator are to be provided. The straight travel reference vector Fs, direction change reference vector Fc and rotating reference vector Fr are developed in advance based on the applied manipulating force of the user. An angle defined by the vector of the manipulating force applied by the user (applied manipulating force vector Fi) and the straight travel reference vector Fs is denoted as α, an angle defined by the applied manipulating force vector Fi and the direction change reference vector Fc as β, and an angle defined by the applied manipulating force vector Fi and the rotating reference vector Fr as γ. Herein the angles are illustrated as α<β<γ, and the moving mode (straight travel mode in this example) is selected in relation with the reference manipulating force vector (the straight travel reference vector Fs in this example) that makes the smallest angle (α).

This application is the national phase under 35 U.S.C. § 371 of PCT International Application No. PCT/JP2004/1657 which has an International filing date of Feb. 16, 2004 and designated the United States of America.

### TECHNICAL FIELD

The present invention relates to a force input manipulator that selects for example an operation mode out of a plurality of operation modes of a mobile object, according to a manipulating force applied to a manipulating unit such as a handle, and thereby outputs a signal that controls a motion of the mobile object, as well as to a mobile object operated by such a force input manipulator, and a push cart and a walker in which the force input manipulator is incorporated.

### BACKGROUND ART

A conventional mobile object such as a push cart or a walker is designed to detect a manipulating force of a user applied to a manipulating unit, and to select an operation mode such as moving straight, changing a direction or rotating, according to the manipulating force. In such a conventional mobile object, the manipulating force is predetermined at a fixed level for each mechanism, and hence the user has to apply a force greater than a certain level in order to operate the mobile object, otherwise the mobile object cannot be operated, and in particular, the operation mode cannot be selected. For example, although a physically challenged person with limited power tries to manipulate the manipulating unit to switch the operating mode, the person is often unable to apply the manipulating force that satisfies the level predetermined for detecting the manipulating force, and thus inhibited from operating the mobile object as desired. Also, when the direction that the user can apply a force is biased, the mobile object may move in a direction different from the intention of the user. (Refer to Japanese Patent Application Laid-Open No.2002-2490, pamphlet under International Publication No. WO98/41182)

As stated above, a conventional mobile object has a drawback that the detection level of the applied manipulating force is fixed, and that therefore it is impossible or difficult to operate the mobile object when the detection level of the mobile object with respect to the applied manipulating force is different from the level of the manipulating force that the user can apply. In addition, when the direction that the user can apply a force is biased, the mobile object may move in a direction different from the intention of the user.

### DISCLOSURE OF THE INVENTION

The present invention has been conceived in view of the foregoing problems, and proposes to determine a detection level with respect to a manipulating force applied, based on a manipulating force that a user can usually apply. In other words, it is an object of the present invention to provide a force input manipulator that determines and stores a reference manipulating force according to a manipulating force that a user can apply with respect to each operation mode, to thereby allow the user, despite being able to only apply a manipulating force of a low (weak) level, to manipulate as desired through a natural feeling without finding difficulty in manipulating, as well as a mobile object provided with such force input manipulator.

The foregoing object includes providing a force input manipulator that offers easy and natural manipulating feeling to all types of users including ordinary users, physically weak users, and users who can only apply a force in a limited direction, based on the function of setting a reference manipulating force according to a manipulating force applied to the manipulating unit, as well as a mobile object provided with such force input manipulator.

It is another object of the present invention to provide a push cart or a walker, by constituting the mobile object as a push cart or a walker, which offers easy and natural manipulating feeling to all types of users including a user who utilizes the mobile object as a push cart, and a user who utilizes the mobile object as a walker.

A first aspect of the present invention provides a force input manipulator that operates an object according to a manipulating force applied to a manipulating unit, comprising an applied force detector which detects the manipulating force applied to the manipulating unit; an operation mode selector which decides a reference manipulating force closest to the detected manipulating force applied out of a plurality of reference manipulating forces stored in advance in correlation with a plurality of operation modes, and selects the operation mode corresponding to the decided reference manipulating force; and a motion control signal generator which outputs a motion control signal for controlling the motion of the object according to the selected operation mode.

Since the force input manipulator according to the first aspect decides the closest reference manipulating force upon comparison with the plurality of reference manipulating forces stored in advance in correlation with the operation modes, and selects the operation mode corresponding to the decided reference manipulating force is selected, a user-friendly force input manipulator can be achieved which allows the user to select the operation mode as desired even when the user can only apply a limited manipulating force to the manipulating unit. Such force input manipulator offers a natural manipulating feeling also to an ordinary user. In addition, the force input manipulator allows a user, who can only apply a force in a limited direction, to correctly select the desired operation mode, thereby equally providing its advantage of user-friendliness.

A second aspect of the present invention provides the force input manipulator according to the first aspect, further comprising means for developing and storing the reference manipulating force based on the applied manipulating force.

The force input manipulator according to the second aspect is capable of developing the reference manipulating force based on the manipulating force actually applied to the manipulating unit, and hence establishing an appropriate reference manipulating force in advance according to a small manipulating force applied by a physically weak user, thereby achieving a user-friendly force input manipulator which can decide a reference manipulating force according to the intention of the user, and allow the user to smoothly select the operation mode.

A third aspect of the present invention provides the force input manipulator according to the first or the second aspect, wherein the applied force detector is a biaxial force sensor that detects a force acting in a direction with respect to the object and in another direction intersecting the first mentioned direction.

According to the third aspect, since a biaxial force sensor is employed as the applied force detector, the manipulating force can be detected by a relatively simple device, and therefore the operation mode can be easily and accurately selected according to the intention of the user.

A fourth aspect of the present invention provides a force input manipulator according to the first or the second aspect, wherein the applied force detector includes a plurality of force sensors, out of which at least two sensors are employed for one direction.

According to the fourth aspect, since the applied force detector includes a plurality of force sensors, out of which at least two sensors are employed for each direction, a rotating manipulating force, in a direction of an axis orthogonal to an axis for which two sensors are provided, can be relatively easily but accurately detected, and therefore the operation mode can be easily and accurately selected according to the intention of the user.

A fifth aspect of the present invention provides a force input manipulator according to the first to the fourth aspects, wherein the operation mode is one of moving straight, changing a direction and rotating.

According to the fifth aspect, the intention of the user can be easily recognized among moving straight, changing a direction and rotating (rotation on the spot), according to the applied manipulating force, and therefore the operation mode can be easily and accurately decided and selected according to the intention of the user.

A sixth aspect of the present invention provides a force input manipulator according to the first to the fifth aspects, wherein the operation mode selector stores a decision region defined by a magnitude and acting direction of the force with respect to each reference manipulating force, so as to specify the decision region to which the applied manipulating force belongs, based on the magnitude and acting direction thereof, and thus to decide the reference manipulating force closest to the applied manipulating force.

According to the sixth aspect, the intention of the user represented by the applied manipulating force can be easily recognized among moving straight, changing a direction and rotating, according to the definition of the decision region, and therefore the operation mode can be easily and accurately decided and selected according to the intention of the user.

A seventh aspect of the present invention provides a force input manipulator according to the first to the fifth aspects, wherein the operation mode selector has a function of deciding the reference manipulating force closest to the applied manipulating force, based on a difference in direction between the acting direction of the applied manipulating force and that of the reference manipulating force.

According to the seventh aspect, the intention of the user can be easily recognized among moving straight, changing a direction and rotating, according to the difference in direction between the acting direction of the applied manipulating force and that of the reference manipulating force, and therefore the operation mode can be easily and accurately decided and selected according to the intention of the user.

An eighth aspect of the present invention provides a force input manipulator according to the first to the fifth aspects, wherein the operation mode selector has a function of utilizing the magnitude and acting direction of the applied manipulating force and those of the reference manipulating force to calculate a distance in a two-dimensional space defined by the magnitude and the direction, and deciding the reference manipulating force closest to the applied manipulating force based on the length of the calculated distance.

According to the eighth aspect, the magnitude and acting direction of the applied manipulating force and those of the reference manipulating force are utilized to calculate a distance in a two-dimensional space defined by the magnitude and the direction, and the intention of the user can be easily recognized among moving straight, changing a direction and rotating based on the length of the calculated distance, and therefore the operation mode can be easily and accurately decided and selected according to the intention of the user, even when the applied manipulating force is small.

A ninth aspect of the present invention provides a mobile object comprising the force input manipulator according to any of the first to the eighth aspect, so as to move according to the motion control signal output by the motion control signal generator.

A tenth aspect of the present invention provides a push cart comprising the mobile object according to the ninth aspect.

An eleventh aspect of the present invention provides a walker comprising the mobile object according to the ninth aspect.

According to the ninth to the eleventh aspects, a user-friendly mobile object, a push cart and a walker can be achieved.

### BRIEF DESCRIPTION OF THE DRAWINGS

FIGS. 1A to 1C are plan views showing operation modes of a mobile object provided with a force input manipulator according to a first embodiment of the present invention;

FIG. 2 is a perspective view showing an outline of the force input manipulator according to the first embodiment, incorporated in the mobile object for selecting an operation mode;

FIG. 3 is a vector diagram showing examples of reference manipulating forces according to the present invention;

FIG. 4 is a vector diagram for explaining a process to select the operation mode by comparison of an applied manipulating force and the reference manipulating force, in the force input manipulator according to the first embodiment;

FIG. 5 is a vector diagram for explaining another process to select the operation mode by comparison of an applied manipulating force and the reference manipulating force, in the force input manipulator according to the first embodiment;

FIG. 6 is a block diagram showing an outline of a control block according to the present invention;

FIG. 7 is a flowchart showing a process of operation mode selection and operating speed calculation, in the force input manipulator according to the first embodiment;

FIG. 8A is a perspective view and FIG. 8B is a plan view, respectively showing a mobile object provided with a force input manipulator according to a second embodiment of the present invention;

FIG. 9 is a plan view showing an outline of the force input manipulator according to the first embodiment, incorporated in the mobile object for selecting the operation mode;

FIG. 10 is a block diagram showing an outline of another control block according to the present invention; and

FIG. 11 is a flowchart showing a process of operation mode selection and operating speed calculation, in the force input manipulator according to the second embodiment.

### BEST MODE FOR CARRYING OUT THE INVENTION

Hereunder, the present invention will be described based on the accompanying drawings illustrating the embodiments thereof.

### First Embodiment

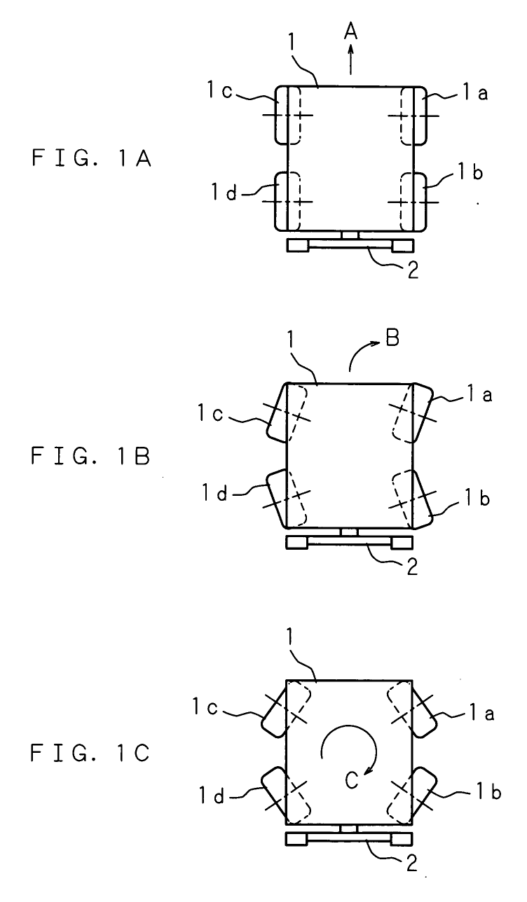

FIGS. 1A to 1C are plan views showing operation modes of a mobile object provided with a force input manipulator according to the first embodiment of the present invention. In these drawings, numeral 1 designates the mobile object, for example a push cart (electric cart) and a walker (electric walker), utilized for assisting a person having difficulty in walking. The mobile object 1 is provided with for example four sets of wheels. FIGS. 1A to 1C depict the status of each wheel of the mobile object 1, seen through from above. The four sets of wheels are respectively denoted as a right front wheel 1a, right rear wheel 1b, left front wheel 1c and left rear wheel 1d. On the mobile object 1, a force input manipulator 2 is mounted. A user applies a manipulating force to the force input manipulator 2 when necessary, so as to select an operation mode of the mobile object 1. In the first embodiment, the operation modes include a straight travel mode (a), direction change mode (b) and rotation mode (c). These three basic operation modes enable all types of movements. The operation modes may be classified in further details.

In FIG. 1A, all of the right front wheel 1a, right rear wheel 1b, left front wheel 1c and left rear wheel 1d are oriented in a straight line, so as to move straight in a direction indicated by the arrow A. In FIG. 1B, the right front wheel 1a and left front wheel 1c are oriented to the right, to which the moving direction is being changed as indicated by the arrow B, while the right rear wheel 1b and left rear wheel 1d are oriented to the left, thus to facilitate the direction change to the right. In FIG. 1C, the right front wheel 1a and left front wheel 1c are oriented to an inner forward direction of the mobile object 1, while the right rear wheel 1b and left rear wheel 1d are oriented to an outer forward direction, so that the mobile object turns around to the right, as indicated by the arrow C. Each of these operation modes can be selected according to a manipulating force applied to the force input manipulator 2. Also, the orientation control (steering control) and drive control of the wheels are performed by a steering unit (not shown) with a known technique, for steering and driving the wheels.

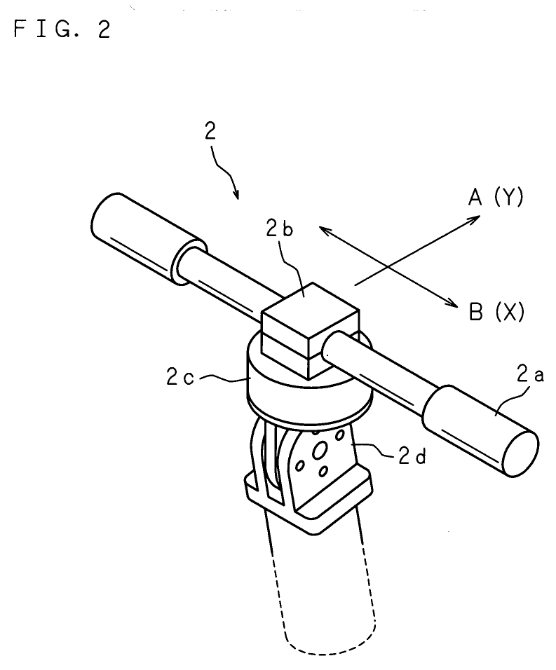

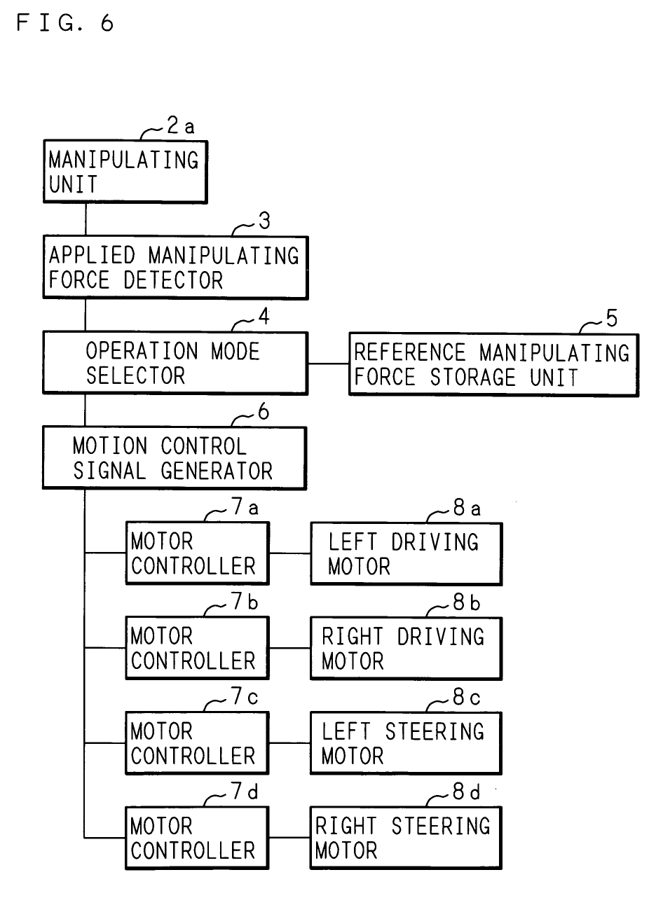

FIG. 2 is a perspective view showing an outline of the force input manipulator 2 according to the first embodiment, incorporated in the mobile object for selecting the operation mode. The force input manipulator 2 includes a manipulating handle 2a which corresponds to the manipulating unit, a handle clamp 2b which fastens the manipulating handle 2a, a biaxial force sensor 2c connected to the handle clamp 2b for detecting a manipulating force applied to the manipulating handle 2a, and a joint portion 2d for attaching the force input manipulator 2 to the main body (not shown) of the mobile object 1. The arrow A indicates for example a moving direction (Y-axis), and the arrow B indicates for example a left and right direction (X-axis). The biaxial force sensor 2c serves as the applied manipulating force detector (Ref. applied manipulating force detector 3 in FIG. 6), which detects a force acting in the moving direction and in left and right direction, and transmits the detected result to the operation mode selector (Ref operation mode selector 4 in FIG. 6). The operation mode selector selects a required operation mode based on the detected result, so that the mobile object 1 is driven in the desired operation mode.

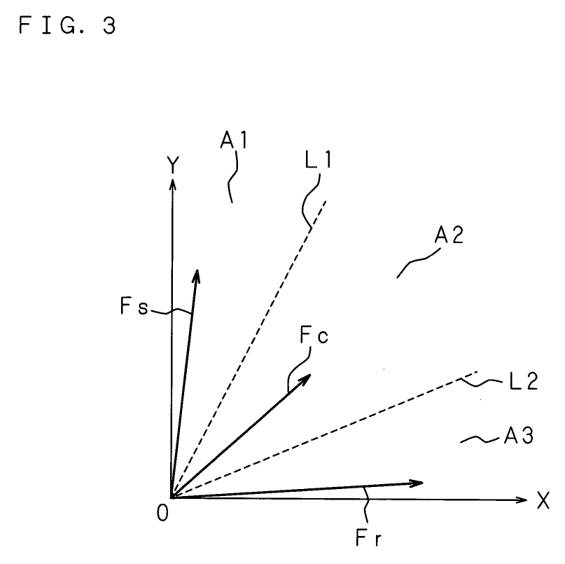

FIG. 3 is a vector diagram showing examples of reference manipulating forces according to the present invention. As an example, the Y-axis corresponds to the moving direction (back and forth direction), and the X-axis corresponds to left and right direction with respect to the moving direction. The first quadrant is divided into three regions to be allocated to the operation mode. For example, a partition line L1 delimits a region A1 and a region A2, and a partition line L2 delimits the region A2 and a region A3. The region A1 corresponds to the straight travel mode; the region A2 corresponds to the direction change mode (in the case a left turn); and the region A3 corresponds to the rotation mode (in this case rotation to the left). The method of dividing the regions for deciding the operation mode is not limited to this example, but the regions may be divided as desired according to a position of the endpoint of the vector of the applied manipulating force. Such arrangement allows properly dividing the regions for deciding the operation mode, elaborately incorporating peculiar manipulating tendencies that are different among individual users.

In each region, a reference manipulating force (reference manipulating force vector) is developed for each operation mode in relation with a representative applied manipulating force, namely a straight travel reference vector Fs, direction change reference vector Fc, and rotating reference vector Fr. These reference manipulating force vectors are appropriately developed in advance according to the magnitude of the reference manipulating force, and stored as a memory. Here, the reference manipulating force may be appropriately determined based on a representative output value of the biaxial force sensor, to be output according to the manipulating force (applied manipulating force, applied manipulating force vector) actually applied by the user. The straight travel reference vector Fs represents the reference manipulating force in the straight travel mode; the direction change reference vector Fc represents the reference manipulating force in the direction change mode; and the rotating reference vector Fr represents the reference manipulating force in the rotation mode.

For developing the reference manipulating force, the force input manipulator may be set in the reference manipulating force developing mode by the reference manipulating force developing means (not shown), and the reference manipulating force is determined for each user and each operation mode, and stored as a memory. To be more detailed, the user actually applies a manipulating force to the force input manipulator in each operation mode, and such manipulating force detected by the applied manipulating force detector 3 is stored as a reference value in the reference manipulating force storage unit (Ref reference manipulating force storage unit 5 in FIG. 6). For example in the straight travel mode, the user applies a force that is comfortable to him/her to the manipulating handle 2a to a forward direction, and the force detected at that moment is stored as a “straight travel mode reference manipulating force” (straight travel reference vector Fs), upon pressing a straight travel mode setting button provided in the reference manipulating force developing means. In the case of the rotation mode, the user applies a force that is comfortable to him/her to the manipulating handle 2a from the left toward the right (in a plus direction along the X-axis), and the force detected at that moment is stored as a “(left) rotation mode reference manipulating force” (rotating reference vector Fr), upon pressing a (left) rotation mode setting button provided in the reference manipulating force developing means. In the case of the direction change mode, the user applies a force that is comfortable to him/her to the manipulating handle 2a from 45 degrees backward to the left to 45 degrees forward to the right, and the force detected at that moment is stored as a “left turn mode reference manipulating force” (direction change reference vector Fc), upon pressing a left turn mode setting button provided in the reference manipulating force developing means.

The reference manipulating force may be individually developed for different users. Developing the individual reference manipulating force for each user through the reference manipulating force developing means allows reflecting a peculiar tendency or unique character of the user to the reference manipulating force, and thus setting an appropriate reference manipulating force for each operation mode based on a manipulating force that is convenient (comfortable) to the user, even when the user is physically challenged. It is also possible to let each user repeatedly apply a manipulating force in each operation mode in the reference manipulating force developing mode, so as to utilize an average manipulating force as the reference manipulating force in each operation mode.

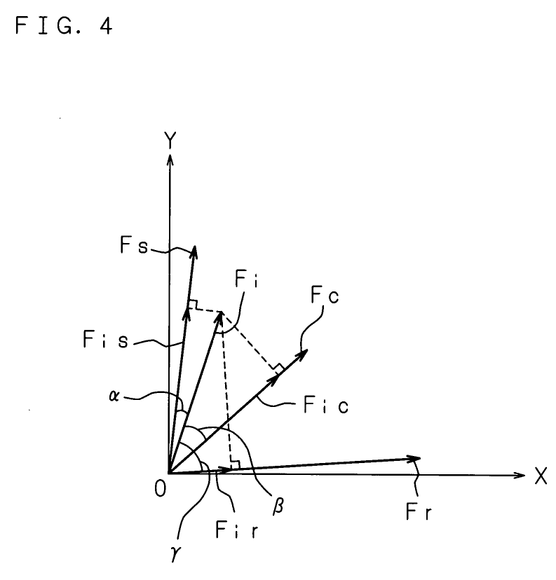

FIG. 4 is a vector diagram for explaining a process to select the operation mode by comparison of an applied manipulating force and the reference manipulating force, in the force input manipulator 2 according to the first embodiment. The following description is made on the assumption that the straight travel reference vector Fs, direction change reference vector Fc and rotating reference vector Fr have been developed in advance based on the applied manipulating force of the user. For example, a vector of a manipulating force actually applied by the user with an intention to select the operation mode is denoted as an applied manipulating force vector Fi. An angle defined by the applied manipulating force vector Fi and the straight travel reference vector Fs is denoted as α, an angle defined by the applied manipulating force vector Fi and the direction change reference vector Fc as β, and an angle defined by the applied manipulating force vector Fi and the rotating reference vector Fr as γ, and the reference manipulating force closest to the manipulating force applied by the user with the intention of selecting the operation mode is decided, based on a correlation (relation in magnitude) among the angles α, β and γ. In FIG. 4, the angles are illustrated as α<β<γ, and therefore the reference manipulating force (reference manipulating force vector) that makes the smallest angle (the angle α in this example), i.e. the straight travel reference vector Fs is selected, and hence the operation mode corresponding to the straight travel reference vector Fs, i.e. the straight travel mode is selected.

The method of selecting the operation mode is not limited to the foregoing method of deciding the reference manipulating force closest to the applied manipulating force directly from the angles, and thus selecting the operation mode.

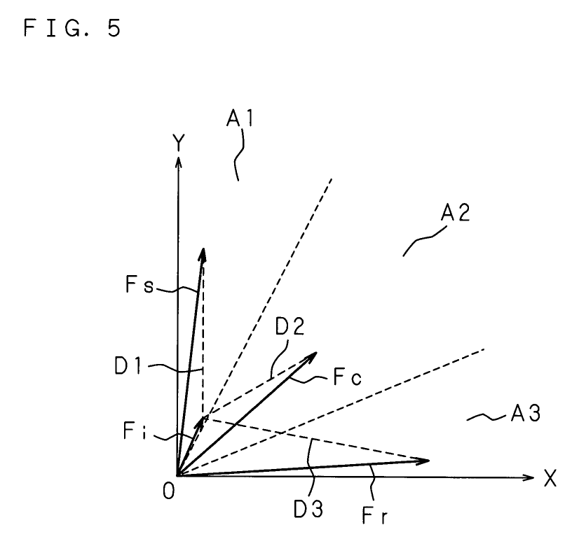

For example, FIG. 5 is a vector diagram for explaining another process to select the operation mode by comparison of an applied manipulating force and the reference manipulating force, in the force input manipulator 2 according to the first embodiment. A vector of a manipulating force actually applied by the user with an intention to select an operation mode is denoted as an applied manipulating force vector Fi. A distance between the endpoint of the applied manipulating force vector Fi and the endpoint of the straight travel reference vector Fs is denoted as D1; a distance between the endpoint of the applied manipulating force vector Fi and the endpoint of the direction change reference vector Fc as D2; and a distance between the endpoint of the applied manipulating force vector Fi and the endpoint of the rotating reference vector Fr as D3; and the reference manipulating force closest to the manipulating force applied by the user with the intention of selecting an operation mode is decided, based on a correlation (relation in length) among the distances D1, D2 and D3. In FIG. 5, the distances are illustrated as D2<D1<D3, and therefore the reference manipulating force (reference manipulating force vector) corresponding to the shortest distance (the distance D2 in this example), i.e. the direction change reference vector Fc is selected, and hence the operation mode corresponding to the direction change reference vector Fc, i.e. the direction change mode is selected.

Alternatively, a projection of the applied manipulating force vector (projected vector) with respect to each reference manipulating force vector may be developed so as to decide the reference manipulating force (reference manipulating force vector) closest to the applied manipulating force (applied manipulating force vector), and to thereby select the operation mode. For example, when the magnitude (length) |Fis| of a projected straight travel vector Fis, which is the projected vector of the applied manipulating force vector Fi with respect to the straight travel reference vector Fs, is denoted as Ficosα; the magnitude (length) |Fic| of a projected direction change vector Fic, which is the projected vector of the applied manipulating force vector Fi with respect to the direction change reference vector Fc, is denoted as Ficosβ; and the magnitude (length) |Fir| of a projected rotating vector Fir, which is the projected vector of the applied manipulating force vector Fi with respect to the rotating reference vector Fr, is denoted as Ficosγ, since the vector magnitudes can be described as Ficosα>Ficosβ>Ficosγ in this example, the straight travel reference vector Fs, which corresponds to the projected straight travel vector Fis having the closest magnitude to the magnitude (length) |Fi| of the applied manipulating force vector Fi, is decided as the reference manipulating force (reference manipulating force vector), and hence the operation mode corresponding to the straight travel reference vector Fs, i.e. the straight travel mode is selected.

The projection of the applied manipulating force vector (projected vector) with respect to each reference manipulating force vector is also utilized in calculating a motion speed in each operation mode, as will be subsequently described. For example, a moving speed (running speed) in the straight travel mode can be determined based on the magnitude Ficosα of the projected straight travel vector Fis.

In addition, a multi-parameter evaluation function may be generated by combination of the foregoing methods, for selecting the operation mode. Such arrangement allows executing more realistic selection of the operation mode.

FIG. 6 is a block diagram showing an outline of a control block according to the present invention. A manipulating force applied to the manipulating handle 2a, which is the manipulating unit, is detected by the applied manipulating force detector 3. The applied manipulating force detector 3 is specifically a biaxial force sensor, as already stated. Naturally, employing a sensor having increased detecting axes (such as a hexaxial sensor) allows performing more precise (more multidimensional) detection. At the operation mode selector 4, the applied manipulating force (applied manipulating force vector Fi) detected by the applied manipulating force detector 3 is compared with the reference manipulating force (reference manipulating force vector, such as the straight travel reference vector Fs, direction change reference vector Fc and rotating reference vector Fr) determined in advance and stored in the reference manipulating force storage unit 5, so as to decide the reference manipulating force closest to the applied manipulating force, and to thereby select the operation mode corresponding to the reference manipulating force. In other words, the operation mode selector 4 decides the reference manipulating force closest to the applied manipulating force out of a plurality of reference manipulating forces developed and stored in advance with respect to a plurality of operation modes (for example, one out of the straight travel reference vector Fs, direction change reference vector Fc and rotating reference vector Fr), and then selects the operation mode corresponding to the reference manipulating force. The reference manipulating force storage unit 5 may be a built-in memory or a portable auxiliary storage device such as a memory card containing the data of each individual user.

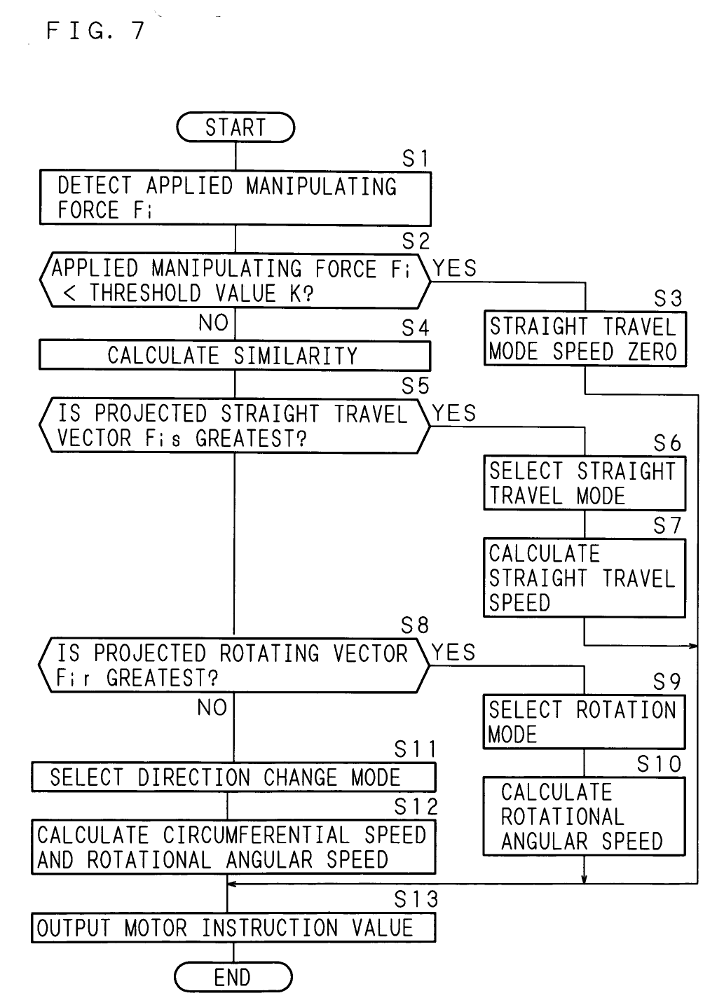

The motion control signal generator 6 calculates the motion speed required by motors 8a to 8d installed on the mobile object 1 for driving the wheels, according to the selected operation mode, and outputs a control signal corresponding to the motion speed to motor controllers 7a to 7d. The motor controllers 7a to 7d supply a predetermined driving current to the motors 8a to 8d respectively, according to the control signal from the motion control signal generator 6. In FIG. 6, the motors are shown as the left driving motor 8a, right driving motor 8b, left steering motor 8c and right steering motor 8d, as an example. Here, the motion speed can also be calculated based on the magnitude of the projection of the applied manipulating force (applied manipulating force vector), i.e. the projected vector, with respect to each reference manipulating force vector, as described referring to FIG. 4. In addition, it is appropriate to develop control parameters for the motion speed according to the operation mode, and a method of developing the control parameters such as a straight motion speed and rotational angular speed will be described hereunder in details referring to FIG. 7.

FIG. 7 is a flowchart showing a process of operation mode selection and operating speed calculation, in the force input manipulator 2 according to the first embodiment. The following description is based on the assumption that the operation modes include three modes, namely the straight travel mode, direction change mode (left turn or right turn mode) and rotation mode.

Firstly, the applied manipulating force detector 3 detects the applied manipulating force (applied manipulating force vector) Fi (step S1). In other words, the biaxial force sensor detects the force in both directions along the X-axis and Y-axis. Here, the X component of the applied manipulating force Fi may be denoted as Fix, and Y component of the same as Fiy. Then it is decided whether the magnitude of the applied manipulating force Fi (length of the vector |Fi|=√(square of Fix+square of Fiy)) is below a predetermined value (a threshold value k) (step S2). If the magnitude of the applied manipulating force Fi is decided to be less than the threshold value k (YES at S2), it is decided that the operation mode intended by the user is the straight travel mode, and the speed is zero (i.e. in a stop mode) (step S3). If the magnitude of the applied manipulating force Fi is decided to be equal to or greater than the threshold value k (NO at S2), it is decided that the user intends another mode than the stop mode.

Then the operation mode selector 4 calculates the similarity (proximity) to the reference manipulating force developed according to the applied manipulating force Fi and the operation mode and stored in the reference manipulating force storage unit 5 (step S4). In other words, the operation mode selector 4 calculates the magnitude of the projection (projected vector) of the applied manipulating force (i.e. the magnitude |Fis| of the projected straight travel vector Fis, the magnitude |Fic| of the projected direction change vector Fic, and the magnitude |Fir| of the projected rotating vector Fir), with respect to the reference manipulating force corresponding to the operation mode (such as the straight travel reference vector Fs, direction change reference vector Fc and rotating reference vector Fr).

The reference manipulating force corresponding to the largest (closest) projected vector out of the calculated projection magnitudes of the applied manipulating force is decided and retrieved, and the operation mode corresponding to the decided and retrieved reference manipulating force is selected. For example, firstly it is decided whether the applied manipulating force corresponds to the straight travel mode, depending on whether the magnitude |Fis| of the projected straight travel vector Fis is the greatest (step S5). If the magnitude of the projected straight travel vector Fis is the greatest (YES at S5), the operation mode selector 4 selects the straight travel mode (step S6). When the straight travel mode is selected, the motion control signal generator 6 calculates the straight moving speed to execute the straight travel mode (step S7). Calculating the straight moving speed (moving speed in the straight travel mode) in proportion to the magnitude |Fis| of the projected straight travel vector Fis provides higher controllability in operating the mobile object 1.

If the magnitude of the projected straight travel vector Fis is not the greatest (NO at S5), it is decided whether the applied manipulating force corresponds to the rotation mode, depending on whether the magnitude of the projected rotating vector Fir is the greatest (step S8). If the magnitude of the projected rotating vector Fir is decided to be the greatest (YES at S8), the operation mode selector 4 selects the rotation mode (step S9). When the rotation mode is selected, the motion control signal generator 6 calculates the rotational angular speed to execute the rotation mode (step S10). Calculating the rotational angular speed for the rotating motion in proportion to the magnitude |Fir| of the projected rotating vector Fir provides higher controllability in operating the mobile object 1.

If the magnitude of the projected rotating vector Fir is not the greatest (NO at S8), the operation mode selector 4 selects the direction change mode (step S11). When the direction change mode is selected, the motion control signal generator 6 calculates the moving speed in a circumferential direction (circumferential speed) in the turning motion and the rotational angular speed with respect to the center of rotation, so as to execute the direction change mode (step S12). Calculating the circumferential speed in proportion to the Y component Fiy of the applied manipulating force Fi, and the rotational angular speed in proportion to the X component Fix of the applied manipulating force Fi provides higher controllability in operating the mobile object 1.

Based on the setting and calculating results of the steps S3, S7, S10 and S12, the motor controllers 7a to 7d accordingly determines an instruction value for the motors, and outputs the value as a motor instruction value (step S13). Repeating the foregoing steps according to the cases leads to achieving the force input manipulator that can smoothly operate the mobile object 1 based on the intention of the user. Also, incorporating a mobile object provided with such a force input manipulator in a push cart or a walker so as to operate the push cart or walker can accomplish a user-friendly push cart or walker.

### Second Embodiment

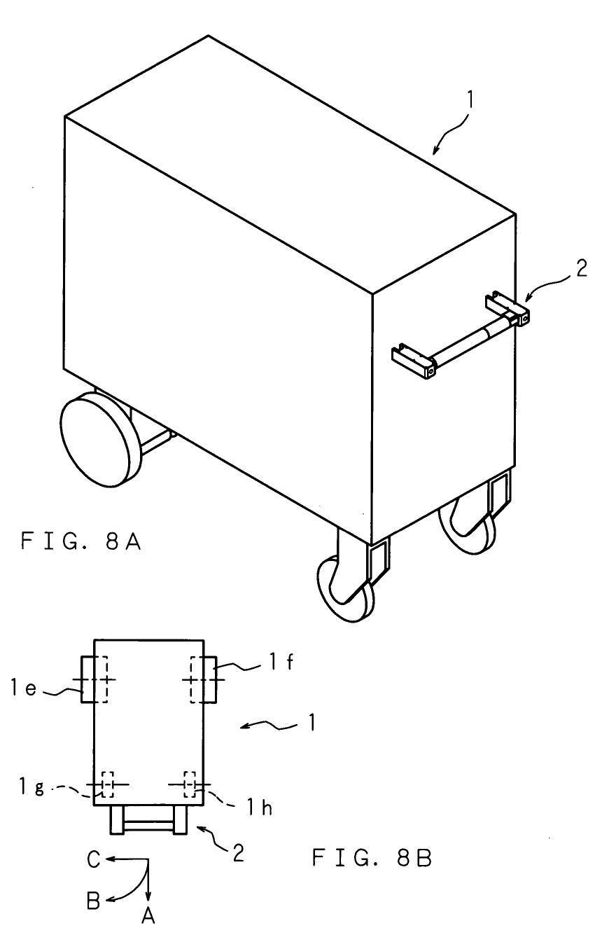

FIG. 8A is a perspective view and FIG. 8B is a plan view, respectively showing a mobile object provided with a force input manipulator according to a second embodiment of the present invention. In FIG. 8A, the numeral 1 designates a mobile object such as an electric cart, used for facilitating transportation of an object that is difficult to carry. The mobile object 1 is provided with, for example, four sets of wheels. FIG. 8B depicts the status of each wheel of the mobile object 1, seen through from above. The four sets of wheels are respectively denoted as a right front wheel 1g, right rear wheel 1e, left front wheel 1h and left rear wheel 1f In the first embodiment, only the right rear wheel 1e and the left rear wheel 1f are driven wheels, which are fixed to a casing of the mobile object 1. the right front wheel 1g and left front wheel 1h are pivotally attached to the casing of the mobile object 1, so as to rotate according to a moving direction thereof. On the mobile object 1, a force input manipulator 2 is mounted. A user applies a manipulating force to the force input manipulator 2 when necessary, so as to select an operation mode of the mobile object 1. In the second embodiment, the operation modes include a straight travel mode, direction change mode and rotation mode, as in the first embodiment. These three basic operation modes enable all types of movements. The operation modes may be classified in further details.

In the straight travel mode indicated by the arrow A in FIG. 8B, both the right rear wheel 1e and left rear wheel 1f rotate in a direction of straight forward movement at a same rotation speed. In the mode of turning to the right as indicated by the arrow B, the right rear wheel 1e and left rear wheel 1f are caused to rotate in different rotation speed and directions, according to the turning radius. In the mode of rotating to the right as indicated by the arrow C, the right rear wheel 1e and left rear wheel 1f are caused to rotate in a same speed, but in the opposite direction. In this way, controlling the rotation of only the left and right rear wheels allows changing the operation mode of the mobile object 1, and the operation modes can be selected according to a manipulating force applied to the force input manipulator 2.

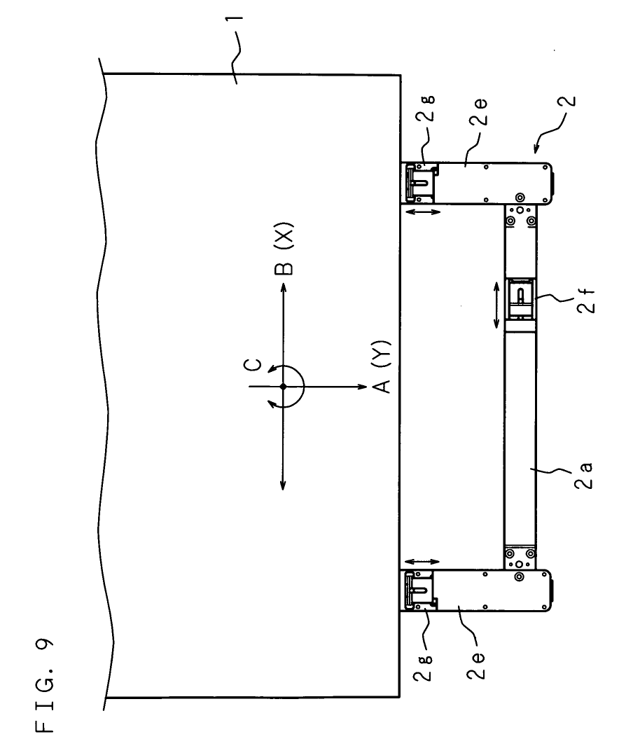

FIG. 9 is a plan view showing an outline of the force input manipulator 2 according to the first embodiment, incorporated in the mobile object for selecting the operation mode. The force input manipulator 2 includes a manipulating handle 2a which is the manipulating unit, and manipulating handle holders 2e, 2e disposed substantially in parallel to each other, so as to support the end portions of the manipulating handle 2a. The manipulating handle 2a includes a pressure sensor 2f located halfway thereof for detecting a pressure in a longitudinal direction along the manipulating handle 2a, and the manipulating handle holder 2e, 2e respectively includes a pressure sensor 2g, 2g located halfway thereof for detecting a pressure in a longitudinal direction along the manipulating handle holder 2e, 2e.

The arrow A indicates for example a moving direction (Y-axis), and the arrow B indicates for example a left and right direction (X-axis). Locating two pressure sensors 2g, 2g in the moving direction (Y-axis) allows also detecting a rotating moment around a Z-axis orthogonal to the X-axis and Y-axis, based on a difference between the pressure values detected by the pressure sensors 2g, 2g.

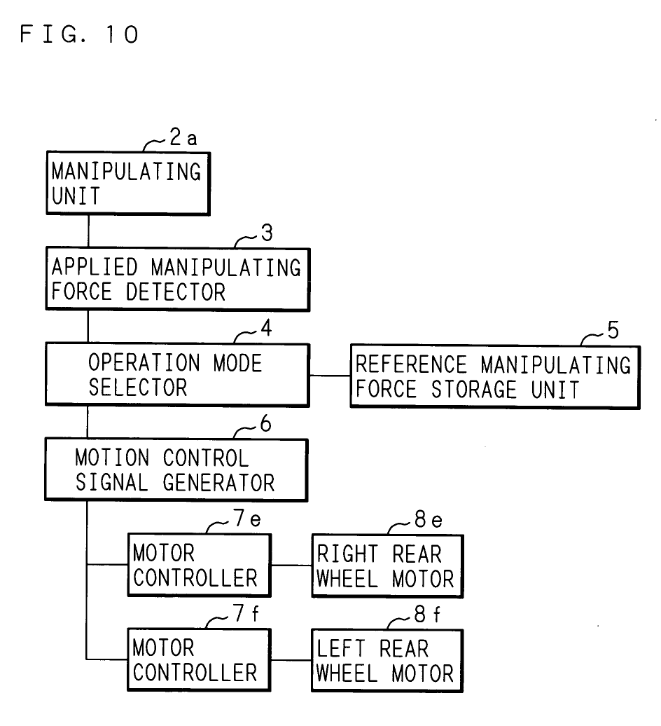

The pressure sensors 2f, 2g, 2g serve as the applied manipulating force detector (Ref. applied manipulating force detector 3 in FIG. 10), for detecting a force in the moving direction and in left and right directions, as well as a rotating moment, and transmitting the detected result to the operation mode selector (Ref. operation mode selector 4 in FIG. 10). The operation mode selector accordingly selects an operation mode based on the detected result, so that the mobile object 1 moves in the desired operation mode.

FIG. 10 is a block diagram showing an outline of another control block according to the present invention. A manipulating force applied to the manipulating handle 2a, which is the manipulating unit, is detected by the applied manipulating force detector 3. The applied manipulating force detector 3 is specifically the plurality of pressure sensors, as already stated. At the operation mode selector 4, the applied manipulating force (applied manipulating force vector Fi) detected by the applied manipulating force detector 3 is compared with the reference manipulating force (reference manipulating force vector) determined in advance and stored in the reference manipulating force storage unit 5, so as to decide the reference manipulating force closest to the applied manipulating force, and to thereby select the operation mode corresponding to the reference manipulating force. In other words, the operation mode selector 4 decides the reference manipulating force closest to the applied manipulating force out of a plurality of reference manipulating forces developed and stored in advance with respect to a plurality of operation modes, and then selects the operation mode corresponding to the reference manipulating force. The reference manipulating force storage unit 5 may be a built-in memory or a portable auxiliary storage device such as a memory card containing the data of each individual user.

The motion control signal generator 6 calculates the motion speed (rotation speed and rotation direction) required by the motors 8e, 8f installed on the mobile object 1 for driving the rear wheels, according to the selected operation mode, and outputs a control signal corresponding to the motion speed to the motor controllers 7e, 7f The motor controllers 7e, 7f supply a predetermined driving current to the motors 8e, 8f respectively, according to the control signal from the motion control signal generator 6. In FIG. 10, the motors are shown as the right rear wheel motor 8e and left rear wheel motor 8f, as an example.

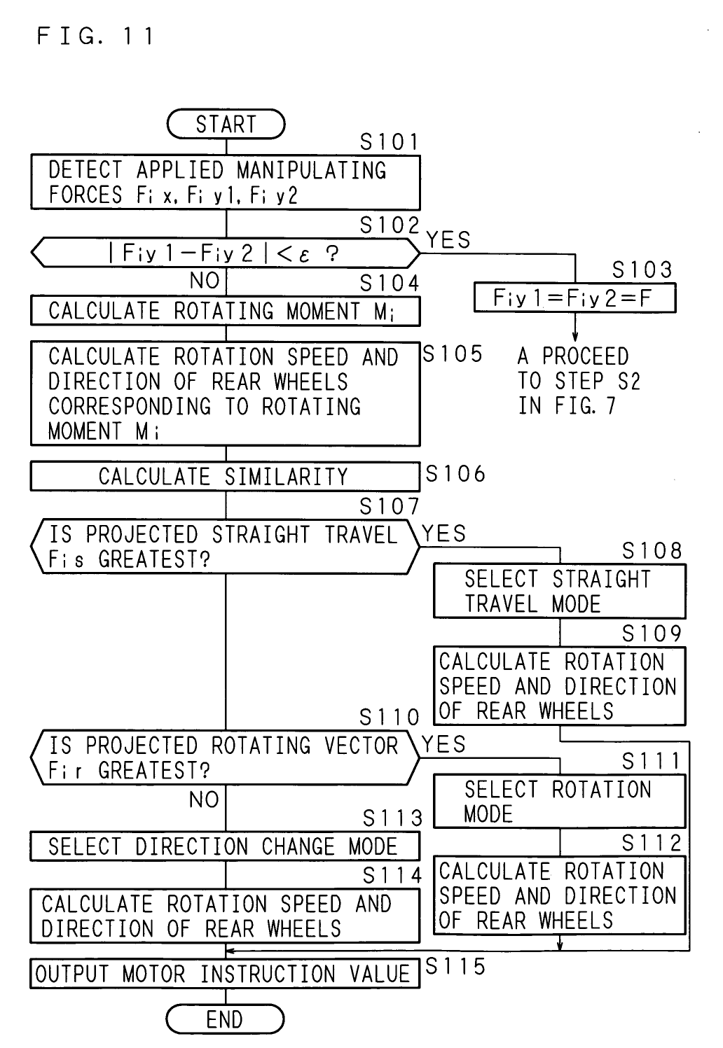

FIG. 11 is a flowchart showing a process of operation mode selection and operating speed calculation, in the force input manipulator according to the second embodiment. The following description is based on the assumption that the operation modes include three modes, namely the straight travel mode, direction change mode (left turn or right turn mode) and rotation mode.

Firstly, the applied manipulating force detector 3 detects the applied manipulating force (applied manipulating force vector) including the force along the X-axis and the force along the Y-axis detected by the pressure sensors (The X component of the applied manipulating force Fi is denoted as Fix, and the Y component as Fiy) (step S101).

It is decided whether an absolute value of a difference between two forces along the Y-axis Fiy1 and Fiy2 detected by the pressure sensors is lower than a predetermined threshold value ε (step S102), and if the absolute value of the difference between the Fiy1 and Fiy2 is decided to be lower than the predetermined threshold value ε (YES at S102), it is judged that the Fiy1 and Fiy2 are substantially equivalent (=Fiy) (step S103), and then a similar process to the first embodiment is performed.

If the absolute value of the difference between the Fiy1 and Fiy2 is decided to be greater than the predetermined threshold value ε (NO at S102), a rotating moment Mi around the Z-axis is calculated (step S104). Then the rear wheel rotation speed and direction corresponding to the reverse rotating moment −Mi (minus Mi), which offsets the calculated rotating moment Mi, is calculated (step S105).

Then the operation mode selector 4 calculates the similarity (proximity) to the reference manipulating force developed according to the applied manipulating force Fi and the operation mode and stored in the reference manipulating force storage unit 5 (step S106). In other words, the operation mode selector 4 calculates the magnitude of the projection (projected vector) of the applied manipulating force (i.e. the magnitude |Fis| of the projected straight travel vector Fis, the magnitude |Fic| of the projected direction change vector Fic, and the magnitude |Fir| of the projected rotating vector Fir), with respect to the reference manipulating force corresponding to the operation mode (such as the straight travel reference vector Fs, direction change reference vector Fc and rotating reference vector Fr).

The reference manipulating force corresponding to the largest (closest) projected vector out of the calculated projection magnitudes of the applied manipulating force is decided and retrieved, and the operation mode corresponding to the decided and retrieved reference manipulating force is selected. For example, firstly it is decided whether the applied manipulating force corresponds to the straight travel mode, depending on whether the magnitude of the projected straight travel vector Fis is the greatest (step S107). If the magnitude of the projected straight travel vector Fis is decided to be the greatest (YES at S107), the operation mode selector 4 selects the straight travel mode (step S108). When the straight travel mode is selected, the motion control signal generator 6 calculates the rotation speed and direction of the left and right rear wheels, taking into consideration the rotation speed and direction calculated at the step S105 (step S109). This allows offsetting the rotating moment generated by the manipulation of the user, and thus causing the mobile object 1 to accurately move straight.

If the magnitude of the projected straight travel vector Fis is decided not to be the greatest (NO at S107), it is decided whether the applied manipulating force corresponds to the rotation mode, depending on whether the magnitude of the projected rotating vector Fir is the greatest (step S110). If the magnitude of the projected rotating vector Fir is decided to be the greatest (YES at S110), the operation mode selector 4 selects the rotation mode (step S111). When the rotation mode is selected, the motion control signal generator 6 calculates the rotation speed and direction of the left and right rear wheels, taking into consideration the rotation speed and direction calculated at the step S105 (step S112). This allows offsetting the rotating moment generated by the manipulation of the user, and thus causing the mobile object 1 to accurately rotate.

If the magnitude of the projected rotating vector Fir is decided not to be the greatest (NO at S110), the operation mode selector 4 selects the direction change mode (step S113). When the direction change mode is selected, the motion control signal generator 6 calculates the rotation speed and direction of the left and right rear wheels, taking into consideration the rotation speed and direction calculated at the step S105 (step S114). This allows offsetting the rotating moment generated by the manipulation of the user, and thus causing the mobile object 1 to change the direction in a desired turning radius.

Based on the rotation speed and direction of the left and right rear wheels calculated at the steps S109, S112 and S114, the motor controllers 7e, 7f accordingly determines an instruction value for the motors, and outputs the value as a motor instruction value (step S115). Repeating the foregoing steps according to the cases leads to achieving the force input manipulator that can smoothly operate the mobile object 1 based on the intention of the user. Also, incorporating a mobile object provided with such a force input manipulator in a push cart or a walker so as to operate the push cart or walker can accomplish a user-friendly push cart or walker.

### INDUSTRIAL APPLICABILITY

As described above in details, according to the first to the eighth aspects of the present invention, since a reference manipulating force closest to reference manipulating forces determined and stored in advance according to an operation mode is decided, so as to select the operation mode corresponding to the decided reference manipulating force, a user-friendly force input manipulator can be attained that allows selecting the operation mode according to the intention of the user, even when the user can only apply a limited force to the manipulating unit. Such force input manipulator offers a natural manipulating feeling also to an ordinary user.

The ninth to the eleventh aspects of the present invention provides an object, a mobile object, a push cart and a walker provided with the force input manipulator according to the first to the eighth aspects of the present invention. Therefore, an easy-to-use, user-friendly push cart or walker can be attained.

1. A force input manipulator that operates an object according to a manipulating force applied to a manipulating unit, comprising:
an applied force detector which detects the manipulating force applied to the manipulating unit;
an operation mode selector which decides a reference manipulating force closest to the detected manipulating force applied out of a plurality of reference manipulating forces stored in advance in correlation with a plurality of operation modes, and selects the operation mode corresponding to the decided reference manipulating force; and
a motion control signal generator which outputs a motion control signal for controlling the motion of the object according to the selected operation mode.

2. The force input manipulator according to claim 1, further comprising means for developing and storing the reference manipulating force based on the applied manipulating force.

3. The force input manipulator according to claim 1, wherein the applied force detector is a biaxial force sensor which detects a force acting in a direction with respect to the object and in another direction intersecting the first mentioned direction.

4. The force input manipulator according to claim 1, wherein the applied force detector includes a plurality of force sensors, out of which at least two sensors are employed for one direction.

5. The force input manipulator according to claim 1, wherein the operation mode is one of moving straight, changing a direction and rotating.

6. The force input manipulator according to claim 1, wherein the operation mode selector stores a decision region defined by a magnitude and acting direction of the force with respect to each reference manipulating force, so as to specify the decision region to which the applied manipulating force belongs, based on the magnitude and acting direction thereof, and thus to decide the reference manipulating force closest to the applied manipulating force.

7. The force input manipulator according to claim 1, wherein the operation mode selector has a function of deciding the reference manipulating force closest to the applied manipulating force, based on a difference in direction between the acting direction of the applied manipulating force and that of the reference manipulating force.

8. The force input manipulator according to claim 1, wherein the operation mode selector has a function of utilizing the magnitude and acting direction of the applied manipulating force and those of the reference manipulating force to calculate a distance in a two-dimensional space defined by the magnitude and the direction, and deciding the reference manipulating force closest to the applied manipulating force based on the length of the calculated distance.

9. A mobile object comprising the force input manipulator according to claim 1, so as to move according to the motion control signal output by the motion control signal generator.

10. A push cart comprising the mobile object according to claim 9.

11. A walker comprising the mobile object according to claim 9.

12. The force input manipulator according to claim 2, wherein the applied force detector is a biaxial force sensor which detects a force acting in a direction with respect to the object and in another direction intersecting the first mentioned direction.

13. The force input manipulator according to claim 2, wherein the applied force detector includes a plurality of force sensors, out of which at least two sensors are employed for one direction.

14. The force input manipulator according to claim 2, wherein the operation mode is one of moving straight, changing a direction and rotating.

15. The force input manipulator according to claim 2, wherein the operation mode selector stores a decision region defined by a magnitude and acting direction of the force with respect to each reference manipulating force, so as to specify the decision region to which the applied manipulating force belongs, based on the magnitude and acting direction thereof, and thus to decide the reference manipulating force closest to the applied manipulating force.

16. The force input manipulator according to claim 2, wherein the operation mode selector has a function of deciding the reference manipulating force closest to the applied manipulating force, based on a difference in direction between the acting direction of the applied manipulating force and that of the reference manipulating force.

17. The force input manipulator according to claim 2, wherein the operation mode selector has a function of utilizing the magnitude and acting direction of the applied manipulating force and those of the reference manipulating force to calculate a distance in a two-dimensional space defined by the magnitude and the direction, and deciding the reference manipulating force closest to the applied manipulating force based on the length of the calculated distance.

18. A mobile object comprising the force input manipulator according to claim 2, so as to move according to the motion control signal output by the motion control signal generator.

19. A push cart comprising the mobile object according to claim 18.

20. A walker comprising the mobile object according to claim 18.
